(19) United States
(12) Patent Application Publication
(10) Pub. No.: US 2025/0282636 A1
(43) Pub. Date: Sep. 11, 2025

(54) PROCESS FOR PRODUCING IRON OXYHYDROXIDE

(71) Applicant: LANXESS Deutschland GmbH, Cologne (DE)

(72) Inventors: Andreas Schlegel, Krefeld (DE); Walter Czaplik, Willich (DE)

(73) Assignee: LANXESS Deutschland GmbH, Cologne (DE)

(21) Appl. No.: 18/267,985

(22) PCT Filed: Dec. 8, 2021
(86) PCT No.: PCT/EP2021/084720

§ 371 Date: Jun. 16, 2023

(30) Foreign Application Priority Data
Dec. 21, 2020 (EP) 20216002.4

(51) Int. Cl. C01G 49/02

(52) U.S. Cl. CPC C01G 49/02

(57) ABSTRACT

The invention relates to a method for preparing iron oxyhydroxides by addition of an aqueous iron salt solution (A) and an alkaline, aqueous precipitant solution (B) to an initial charge while maintaining a pH in the range of 6 to 10.

The invention relates to a method for preparing iron oxyhydroxides.

Iron oxyhydroxides, which are obtained by precipitation of iron(III) salts with an alkaline precipitant or by precipitation of iron(II) salts with an alkaline precipitant and subsequent oxidation, have numerous applications as colour pigments. But also other applications are known fields of application, for example as adsorbers or catalysts for producing polymers. Particularly when used as catalysts, high demands are placed on the by-product spectrum.

The preparation of iron oxyhydroxides is described, for example, in EP1582505A1, wherein either an iron(III) sulfate solution is specified and NaOH is added as precipitant or vice versa. Via the following synthetic route, for example, amorphous iron(III) hydroxide is accessible.

Fe₂(SO₄)₃+6 NaOH→2 Fe(OH)₃+3 Na₂SO₄

According to the method described above, the NaOH precipitant is initially charged and the iron salt is added thereto, thereby obtaining iron oxyhydroxide as product having a very high Na content. Proceeding in the reverse manner and adding the NaOH precipitant to the initially charged iron salt, iron oxyhydroxide is obtained as product having a very high sulfur content. The iron oxyhydroxide prepared by both variants, however, have excessive sodium and/or sulfur contents, particularly for catalyst applications, which cannot be significantly reduced in either case even by multiple washings.

The preparation of iron oxyhydroxides starting from an initially charged iron(II) sulfate solution by adding NaOH and subsequent air oxidation also results in iron oxyhydroxides having excessive sodium and sulfur contents which cannot be significantly reduced by multiple washings either. A corresponding method is described, for example, in WO02/026632.

In this case, white Fe(OH)₂ precipitates from iron(II) salt solutions by addition of aqueous alkaline solution with exclusion of air. Oxidation then takes place in air via grey-green, dark green, blackish intermediate stages. While largely crystalline phases are obtained when Fe(OH)₂ is oxidized, Fe(OH)₃ is formed in amorphous form when an iron(III) salt solution is mixed with hydroxides. In this case, iron(III) hydroxide Fe(OH)₃ typically precipitates as a water-containing hydrogel of the formula Fe₂O₃·n H₂O (“iron(III) oxyhydrate”).

The ion [Fe(H₂O)₆]³⁺ is stable at pH<0 and converts at pH=0-2 to yellow-brown [Fe(OH)(H₂O)₅]²⁺, at pH 2-3 to [Fe(OH)₂(H₂O)₄]⁺ and polynuclear complexes, for example

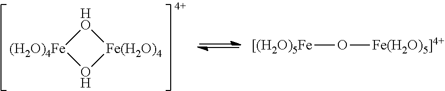

and at pH 3-5 to polynuclear isopolyoxo cations. Further polymerization leads to red-brown colloidal spherical polynuclear species. The water-containing hydrogel is amorphous, structureless, which means although there is a local close order of the anions (OH—) and (O₂—) to the central Fe³⁺ cation, there is no long-range order, i.e. three-dimensional regular repetition of a structural element in space to form a crystal lattice.

Therefore, established in the literature is also the term “two line ferrihydrite”, often specified as the formula Fe₂O₃·nH₂O, in order to document the undefined water content [U. Schwertmann, R. M. Cornell, Iron Oxides in the Laboratory, pp. 103-112, Wiley-VCH, 2000].

It consists of largely amorphous iron hydroxide which exhibits two very broad signals in the X-ray powder diffractogram. Specific surface areas according to the BET method of ca. 280 to 350 m₂/g can be measured.

Not only sulfur in the form of sulfate and sodium ions, which originate from the corresponding reactants, the iron salt or the precipitant, are firmly incorporated into the iron hydroxide lattice by the known method and cannot be fully removed even by intensive washing by demineralized washing. In the case of other iron sources, such as in the case of iron(III) chloride, the chlorine content is also difficult to reduce, although this is undesirable in most cases due to the tendency to corrosion.

If the precipitation is carried out, for example, starting from iron(III) chloride, the phase β-FeOOH (akaganeite) is preferably formed, which due to its particular structure has high chloride contents. The same applies to the anions of other iron sources and cations of the precipitant.

The object of the present invention was therefore to provide a method by which iron oxyhydroxides are possible having the lowest possible content of cations originating from the precipitant, especially alkali metals and/or alkaline earth metals, and at the same time the lowest possible content of anions originating from the iron salts, especially sulfur and/or chloride.

### METHOD

The invention therefore relates to a method for preparing iron oxyhydroxides which is characterized in that
i) an aqueous iron salt solution (A) and an alkaline, aqueous precipitant solution (B). preferably an alkali metal hydroxide solution, are mixed with each other, wherein the mixing is carried out such that the pH in the mixture being formed in an initial charge during the addition of (A) and (B) is maintained in the range of 6 to 10,
ii) wherein in the case of an aqueous iron salt solution (A) of an Fe(II) salt, oxygen-containing gas is introduced for the oxidation of Fe(II) to Fe(III) during or after the mixing of (A) and (B),
iii) the suspension obtained after step i) or ii) is separated from the solid,
iv) the solid obtained after step iii), in particular the filter cake, is washed with demineralized (DM) water, preferably up to a filtrate conductivity of less than 2000 μS/cm and
v) the washed solid after step iv) is dried.

### IRON OXYHYDROXIDES

The iron oxyhydroxides to be prepared by the method according to the invention include the crystalline forms such as FeO, Fe₂O₃, Fe₃O₄ and FeOOH and also the amorphous forms such as Fe(OH)₃ and the water-containing hydrogels thereof.

### STEP i

### Iron Salt Solution (A)

The iron salt of the aqueous iron salt solution (A) used may be both iron(II) and iron(III) salts. In the case of iron(III) salts, which are preferred, preferably iron(III) sulfate, iron(III) nitrate, iron(III) chloride, iron(III) phosphate, iron(III) chloride sulfate or any other iron(III) salt may be used. Preference is given to iron(III) sulfate or iron(III) chloride.

In the case of iron(II) salts, preferably iron(II) sulfate, iron(II) nitrate, iron(II) chloride, iron(II) phosphate or any other iron(II) salt may be used. Preference is given to iron(III) chloride or iron(II) sulfate.

Depending on the anion used in the method according to the invention, the remaining proportion thereof can be very much reduced in the resulting iron oxyhydroxide. This proportion is typically measured, by way of example, as the sulfur content for sulfate, preferably as the chloride content for chloride and as the nitrate content for nitrate.

The aqueous iron salt solution (A) preferably comprises from 10 to 1000 g/L, preferably 50 to 800 g/L of iron salt, based on the aqueous iron salt solution (A). In addition to water, the solution may also contain organic solvents, of which mention may be made for example of those aliphatic solvents such as methanol, ethanol, propanol such as isopropanol, butanol or others.

The proportion of water, based on the total content of solvent in the aqueous iron salt solution (A), is preferably from 90 to 100% by weight, preferably 99 to 100% by weight.

### Alkaline, Aqueous Precipitant Solution (B)

The precipitant of the alkaline aqueous precipitant solution (B) is, for example, alkali metal or alkaline earth metal hydroxides and used in particular are NaOH or KOH or Ca(OH)₂, alkali metal or alkaline earth metal carbonates such as Na₂CO₃, K₂CO₃, CaCO₃ or MgCO₃, alkaline earth metal oxides such as MgO or CaO or NH₃ or NH₄OH. Component (B) is preferably an alkali metal hydroxide solution.

The alkaline, aqueous precipitant solution (B) preferably comprises from 10 to 600 g/L, preferably 50 to 440 g/L of precipitant, based on the solution. In addition to water, the solution may also contain organic solvents, of which mention may be made for example of those aliphatic solvents such as methanol, ethanol, propanol such as isopropanol, butanol or others.

The proportion of water, based on the total content of solvent in the aqueous precipitant solution (B), is preferably from 90 to 100% by weight, preferably 99 to 100% by weight.

The initial charge to which both solutions (A) and (B) are added is preferably an empty container or a container comprising water. The pH can be measured by a pH probe in the reaction mixture, preferably reaction suspension. The mixing can already take place during the addition, for example by means of a mixing element for the addition streams or only in the initial charge, for example by means of a mixing element attached thereto. Stirrers or static mixers are suitable as customary mixing elements. Air may also be introduced during addition to the initial charge as an aid to thorough mixing. This can also be the case when using Fe(III) salts which do not have to be oxidized during or after addition.

The components (A) and (B) may be added to the initial charge continuously or in portions.

To determine pH, any commercial pH probe may be used.

Both components (A) and (B) are preferably added such that, by means of the addition of the two components (A) and (B), a pH is maintained in the range of 6 to 10, especially of 6.5 to 9.5 during the addition. The addition is preferably effected at a selected pH with a deviation of +/−0.5 pH units.

The pH generally changes more sharply at the start of addition in relation to the starting pH of the initial charge so that the pH value usually stabilizes around a value only after a short initial period. The pH is therefore preferably adjusted in the particular range so that this is within said range over 95% of the entire addition period of A) and B) to the initial charge, in particular the desired pH being in this range preferably with a deviation of +/−0.5 pH units. The iron salt solution (A) is preferably added to the initial charge continuously, preferably at a constant addition rate, and the precipitant solution (B) is added so that the desired pH can be kept within the specified range.

In this case, during addition of A) and B) to the initial charge, fluctuations in the addition from the respective desired stoichiometric ratio of the two components may occur. Deviations from the respective desired stoichiometric ratio of up to 10% of the stoichiometry during the addition are thus quite normal.

The mixing takes place preferably at a free temperature level, particularly preferably at a temperature of 10 to 100° C.

After mixing components (A) and (B), an aqueous suspension of iron oxyhydroxides is obtained. The resulting solid particles preferably have a BET surface area of 50 to 400 g/m₂, preferably of 50 to 300 g/m₂.

### STEP ii

If an iron salt of oxidation state +2 is used, oxygen or an oxygen-containing gas, especially air, is added preferably already during the mixing of the two components A) and B). This is preferably effected by introducing oxygen or an oxygen-containing gas into the initial charge during the addition of both components. Oxygen or an oxygen-containing gas may also be introduced into the initial charge following the addition of the two components A) and B).

### STEP iii

The aqueous suspension obtained after step ii) or iii) is separated from the solid, preferably by filtration, for example filtered by means of a filter press or by centrifugation.

### STEP iv

The solid obtained after step iii), in particular the filter cake, is preferably washed with demineralized (DM) water, preferably up to a filtrate conductivity of <1000 μS/cm, particularly <300 μS/cm, particularly preferably <100 μS/cm. The measurement of the filtrate conductivity is determined in this case using customary conductivity measuring devices.

### STEP v

The solid obtained after washing according to step iv) is typically dried at a temperature of 60 to 300° C., especially at 60 to 100° C. Customary pigment driers are suitable as driers. The solid is preferably dried up to a residual moisture of less than 1% by weight water, based on the solid.

The drying can also be followed by milling in order to achieve, for example, dispersion of the agglomerates and aggregates. This may be advantageous to enable, for example, a uniform dispersal in the application medium.

### EXAMPLES

### Comparative Example 1 (=Comparative 1) (Analogous to Example 1 of EP1582505)

15 L of Fe₂(SO4) 3 solution having an Fez (SO4); content of 107 g/L were initially charged at 50°° C. and precipitated with 3.5 L of NaOH solution (302 g/L) and at an addition rate of 67 g/min while stirring to pH 7 and the mixture post-stirred for 30 minutes. The resulting final suspension comprises 37 g/FeOOH.

Ca. 5 L of the resulting suspension were washed on a laboratory filter press with DM water up to a filtrate conductivity of <100 μS/cm. The filter cake was dried at 75° C. in an air circulation drying cabinet and the dried iron hydroxide lightly ground with a laboratory mill.

Elemental analysis see table 1

### Comparative Example 2 (=Comparative 2) (Analogous to Example 1 of EP1582505)

15 L of Fe₂(SO₄); solution (107 g/L) were initially charged at 50° C. and precipitated with 3.4 L of NaOH solution (309 g/L) and at an addition rate of 65 g/min while stirring to pH 8 and the mixture post-stirred for 30 minutes. The resulting final suspension comprises 37 g/FeOOH.

Ca. 5 L of the resulting suspension were washed on a Nutsche filter to a filtrate conductivity of 146 μS/cm, the resulting filter cake dried at 75° C. in an air circulation drying cabinet and the dried iron hydroxide comminuted with a laboratory coarse grinder.

Elemental analysis see table 1

### Comparative Example 3 (=Comparative 3) (Analogous to Example 3 of EP1582505)

16 L of NaOH solution (60 g/L NaOH) were initially charged and heated to 50° C. with stirring. Then, at a free temperature level, 2.4 L of Fe₂(SO₄)₃ solution (107 g/L Fe₂(SO₄)₃) were added at an addition rate of 65 g/min to pH 9.

The mixture was further stirred for 15 minutes.

The batch was then washed on a laboratory filter press up to a filtrate conductivity of <100 μS/cm. The filter cake was dried to constant weight at 75° C. in an air circulation drying cabinet and the solid lightly milled with a laboratory mill.

Weight: 301 g of solid

Elemental analysis see table 1

### Example 1 (Inventive)

12 186 g of demineralized (DM) water were initially charged and heated to 50° C. with stirring. At a free temperature level, 4200 g of Fe₂(SO₄)₃ solution (637 g/L, 42% Fe₂(SO4)₃) were then added at an addition rate of 32 g/min, where the pH was maintained at 7.0 by simultaneous addition of NaOH solution (313 g/L NaOH).

The resulting suspension was washed on a laboratory filter press up to a filtrate conductivity of <90 μS/cm. The filter cake was dried at 75° C. in an air circulation drying cabinet and the dried solid lightly ground with a laboratory mill.

Weight: 640 g of solid

Analyses: FeOOH content in suspension=39.7 g/L; BET=93 m²/g

Elemental analysis see table 1.

### Example 2 (Inventive)

12 186 g of DM water were initially charged and heated to 50° C. with stirring. At a free temperature level, 4200 g of Fe₂(SO₄)₃ solution (637 g/L, Fe₂(SO₄)₃) were then added at an addition rate of 32 g/min, where the pH was maintained at 8.0 by simultaneous addition of NaOH solution (313 g/L NaOH).

The resulting suspension was washed on a laboratory filter press up to a filtrate conductivity of <90 μS/cm. The filter cake was dried at 75° C. in an air circulation drying cabinet and the dried solid lightly ground with a laboratory mill.

Weight: 681 g of solid

Analysis: FeOOH content in suspension=51.6 g/L; BET=126 m²/g

Elemental analysis see table 1

### Example 3 (Inventive)

12 186 g of DM water were initially charged and heated to 50° C. with stirring. At a free temperature level, 4200 g of Fe₂(SO₄)₃ solution (637 g/L, Fe₂(SO₄)₃) were then added at an addition rate of 32 g/min, where the pH was maintained at 8.5 by simultaneous addition of NaOH solution (313 g/L NaOH).

The resulting suspension was washed on a laboratory filter press up to a filtrate conductivity of <90 μS/cm. The filter cake was dried at 75° C. in an air circulation drying cabinet and the dried solid lightly ground with a laboratory mill.

Weight: 661 g of solid

Analysis: FeOOH content in suspension=42.4 g/L; BET=152 m²/g

Elemental analysis see table 1

### Example 4 (Inventive)

12 186 g of DM water were initially charged and heated to 50° C. with stirring. At a free temperature level, 4200 g of Fe₂(SO4)₃ solution (637 g/L, Fe₂(SO₄)₃) were then added at an addition rate of 32 g/min, where the pH was maintained at 9.0 by simultaneous addition of NaOH solution (313 g/L NaOH).

The resulting suspension was washed on a laboratory filter press up to a filtrate conductivity of <90 μS/cm. The filter cake was dried at 75° C. in an air circulation drying cabinet and the dried solid lightly ground with a laboratory mill.

Weight: 660 g of solid

Analysis: FeOOH content in suspension=41.1 g/L; BET=177 m²/g

Elemental analysis see table 1

### Example 5 (Inventive)

12 055 g of DM water were initially charged and heated to 50° C. with stirring. At a free temperature level, 4167 g of FeCl₃ solution (517 g/L FeCl₃) were then added at an addition rate of 28 g/min, where the pH was maintained at 8.0 by simultaneous addition of KOH solution (420 g/L KOH).

The suspension was washed on a laboratory filter press up to a filtrate conductivity of <90 μS/cm. The filter cake was dried at 75° C. in an air circulation drying cabinet and the dried solid lightly ground with a laboratory mill.

Weight: 656 g of solid

Analysis: FeOOH content in suspension=40.6 g/L; BET=162 m²/g

Elemental analysis see table 1

### Example 6 (Inventive)

10 840 g of DM water were initially charged at 25° C. with stirring. At a free temperature level, 7205 g of FeSO₄ solution (249 g/L FeSO₄) were then added at an addition rate of 100 g/min, where the pH was maintained at 8.5 by simultaneous addition of NaOH solution (313 g/L NaOH). 800 L/h of air was also added at the same time as the addition of the NaOH solution.

The resulting suspension was washed on a laboratory filter press up to a filtrate conductivity of <90 μS/cm. The filter cake was dried at 75° C. in an air circulation drying cabinet and the dried solid lightly ground with a laboratory mill.

Weight: 704 g of solid

Analysis: FeOOH content in suspension=38.7 g/L; BET=121 m²/g

Elemental analysis see table 1

### Example 7 (Inventive)

10 840 g of DM water were initially charged at 25° C. with stirring. At a free temperature level, 7205 g of FeSO₄ solution (249 g/L FeSO₄) were then added at an addition rate of 100 g/min, where the pH was maintained at 9.0 by simultaneous addition of NaOH solution (313 g/L NaOH). 800 L/h of air was also added at the same time as the addition of the NaOH solution.

The resulting suspension was washed on a laboratory filter press up to a filtrate conductivity of <90 μS/cm. The filter cake was dried at 75° C. in an air circulation drying cabinet and the dried solid lightly ground with a laboratory mill.

Weight: 707 g of solid

Analysis: FeOOH content in suspension=39.8 g/L; BET=121 m²/g

Elemental analysis see table 1

TABLE 1
Elemental analyses:

| | | | BET | Na | S | K | Cl |
|---|---|---|---|---|---|---|---|
| Example | Method | pH | [m²/g] | [ppm] | [ppm] | [ppm] | [ppm] |
| Comparative 1 | Initial charge Fe(III) | 7 | | 200 | 26000 | | |
| Comparative 2 | Initial charge Fe(III) | 8 | 350 | 140 | 13000 | | |
| Comparative 3 | Initial charge NaOH | 9 | | 8200 | 190 | | |
| 1 | Simultaneous precipitation with | 7.0 | 93 | 178 | 5059 | — | — |
| | Fe₂(SO₄)₃ and NaOH | | | | | | |
| 2 | Simultaneous precipitation with | 8.0 | 126 | 71 | 3648 | — | — |
| | Fe₂(SO₄)₃ and NaOH | | | | | | |
| 3 | Simultaneous precipitation with | 8.5 | 152 | 330 | 487 | — | — |
| | Fe₂(SO₄)₃ and NaOH | | | | | | |
| 4 | Simultaneous precipitation with | 9.0 | 177 | 704 | 419 | — | — |
| | Fe₂(SO₄)₃ and NaOH | | | | | | |
| 5 | Simultaneous precipitation with | 8.0 | 162 | — | — | 300 | 170 |
| | FeCl₃ and KOH | | | | | | |
| 6 | Simultaneous precipitation with | 8.5 | 121 | 105 | 1068 | — | — |
| | FeSO₄ and NaOH | | | | | | |
| 7 | Simultaneous precipitation with | 9.0 | 121 | 283 | 680 | — | — |
| | FeSO₄ and NaOH | | | | | | |

1. Method for preparing iron oxyhydroxides, wherein
i) an aqueous iron salt solution (A) and an alkaline, aqueous precipitant solution (B) are mixed with each other, wherein the mixing is carried out such that the pH in the mixture being formed in an initial charge during the addition of (A) and (B) is maintained in the range of 6 to 10,
ii) wherein in the case of an aqueous Fe(II) salt solution (A), oxygen-containing gas is introduced for the oxidation of Fe(II) to Fe(III) during or after the mixing of (A) and (B),
iii) the suspension obtained after step i) or ii) is separated from the solid,
iv) the solid obtained after step iii) is washed with DM water, and
v) the solid obtained after step iv) is dried.

2. The method according to claim 1, wherein the iron salt of the aqueous iron salt solution (A) employed is an Fe(III) salt.

3. The method according to claim 1, characterized in that the iron salt of the aqueous iron salt solution (A) employed is iron(III) sulfate.

4. The method according to claim 1, wherein the alkaline aqueous precipitant solution (B) employed is an aqueous alkali metal hydroxide solution.

5. The method according to claim 1, wherein the mixing is carried out such that the pH of the mixture being formed in the initial charge is maintained at 6.5 to 9.5.

6. The method according to claim 1, wherein the alkaline, aqueous precipitant solution (B) is an alkali metal hydroxide solution.

7. The method according to claim 1, wherein the solid obtained after step iii) is washed with DM water up to a filtrate conductivity of less than 2000 μS/cm.

8. The method according to claim 2, wherein the Fe(III) salt of the aqueous iron salt solution (A) is iron(III) sulfate.

9. The method according to claim 2, wherein the Fe(III) salt of the aqueous iron salt solution (A) is iron(III) chloride.

10. The method according to claim 2, wherein the Fe(III) salt of the aqueous iron salt solution (A) is iron(III) chloride sulfate.

11. The method according to claim 2, wherein the Fe(III) salt of the aqueous iron salt solution (A) is iron(III) nitrate.

12. The method according to claim 4, wherein the aqueous alkali metal hydroxide solution of the alkaline aqueous precipitant solution (B) is a NaOH solution.

13. The method according to claim 4, wherein the aqueous alkali metal hydroxide solution of the alkaline aqueous precipitant solution (B) is a KOH solution.
